(19) United States
(12) Patent Application Publication
(10) Pub. No.: US 2005/0105725 A1
(43) Pub. Date: May 19, 2005

(54) Method and system for on-line delivery of advertising release material and confirmation of on-air transmission

(76) Inventor: Jae Eun Lee, Seoul (KR)

Correspondence Address: Norris McLaughlin & Marcus, 220 East 42nd Street, 30th Floor, New York, NY, 10017, US

(21) Appl. No.: 10/504,402

(22) PCT Filed: Feb. 19, 2002
(86) PCT No.: PCT/KR02/00253

(51) Int. Cl. H04L 9/00

(52) U.S. Cl. 380/200; 713/176

(57) ABSTRACT

The present invention provides an advertisement transmission and broadcast confirmation system via on-line for inserting a specific ID code invisibly and inaudibly to each advertisement, transmitting the advertisement to an broadcasting station, reading out the ID code released with the advertisement from the broadcasting station, and confirming broadcast results and storing in a server, the broadcast results being sent to an advertiser's computer so that the advertiser can check the broadcasting status of the advertisement in real time. The present method comprises the steps of: (a) linking advertisers' and broadcasters' computers and an ID code reading device to a server via wire and/or wireless Internet; (b) giving an ID code to each advertisement submitted by advertisers, inserting the ID code to the advertisement and transmitting it to the broadcasters' computer; (c) producing and transmitting a broadcast review code for the broadcast station to the server, the broadcast review code includes the ID code which is read out from wire or wireless electric wave of a broadcast station, a radio frequency of broadcast station, a broadcasting date/time and a broadcasting length (seconds); and (d) making broadcast review for an advertiser from comparing/analyzing the broadcast review code which is received from the ID code reading means and sending the review to advertisers' computer in real time.

### TECHNICAL FIELD

The present invention relates to a system and method of advertisement transmission and broadcast confirmation via on-line, more particularly, to a system and method of transmitting the advertisement and then confirming whether it is rightly broadcasted or not by inserting a specific advertisement identification code invisibly and inaudibly to each advertisement, transmitting the advertisement to an broadcasting station, reading out the advertisement identification code released with the advertisement from the broadcasting station, and confirming broadcast results and storing in a server, the broadcast results being sent to an advertiser's computer which is linked with the server via Internet so that the advertiser can check the broadcasting status of the advertisement in real time.

### BACKGROUND ARTS

An advertisement identification code (hereinafter referred to as “ID code”) is inserted and read out by applying watermarking technology.

Generally, the watermarking technology is extensively used in digital content to prevent unauthorized copy and alteration. This watermarking technology is more valuable and essential in the field of broadcast advertising simplifying the complicated distribution process of advertisement between advertiser and broadcaster. From now on, the advertiser has faced a double burden not only in paying for shooting the advertisement campaign but also in taking the cost of monitoring the advertisements. However, the watermarking technology makes possible to reduce advertising costs and time by facilitating the procedure of commercial classification and identification.

Current method of advertisement (advertising material) transmission and broadcast confirmation works like following. First, advertisers make a commercial message, deliver it to broadcasters and ask for release. Then, a broadcast station arranges the broadcasting order of each advertisement, edits the series of commercial messages and sends out on the designated time. After the commercial messages are broadcasted, the advertisers check whether it is performed or not through watching/listening or recording.

In more detail, the advertisers keep the advertising material in the form of a videotape or a recording tape made by advertising agencies. This tape is copied as same with the number of broadcast stations contracted to do advertising campaign and sent to each broadcaster.

The broadcast station transforms the advertising material, i.e. a videotape or a recording tape to a digital file, stores the processed digital file to a computer and makes a list of broadcasting order. According to this order, the stored commercial message is read out, edited and transmitted on the designated time.

Once the commercial message is shot, monitoring is left to be done. The advertisers directly watch TV or listen to radio which the advertisement campaign is supposed to be performed, otherwise record it and keep the track by writing down the broadcasting time, advertising content and so on.

So far, the whole procedure of advertisement transmission and broadcast confirmation depends only on human labor, so fallacies or mistakes can be caused and cost and time are consumed a lot.

In fact, the advertisers distributed stored media, such as videotapes or recording tapes of 36,000 commercials in 2000 to more than 200 broadcast networks by mail or personal delivery in Korea. Estimating the total volume of copied tapes, lots of labor, time and cost are wasted. In addition, each broadcast station has to transform and edit that large volume of commercials applicable to release and prepare a big bulk of storage medium. Therefore, the broadcasters as well as the advertisers cannot but bear labor, time and cost to be unnecessarily spent. Any broadcast network over the nation faces this situation evenly.

By the way, there are two ways to check whether the commercial is properly broadcasted or not. One is monitoring by watching TV or listening to radio or recording first and confirming later by replaying it. The other is outsourcing the broadcast confirmation work. However, monitoring by a outsourcing company is also done through the above-described process. Therefore, there is no difference from the process of checking advertisements. Accordingly, since lots of time, labor and cost are needed in either ways, none of the advertisers or outsourcing companies can monitor more than 200 broadcast stations totally, so they only confine confirmation works to part of them.

What makes the matters worse is when the era of satellite broadcasting comes, the number of broadcasters might be more than two times and the process of commercial transmission and broadcast confirmation will be out of control.

Accordingly, current process of advertisement transmission and broadcast confirmation is inefficient and wastes lots of time, labor and cost.

### SUMMARY OF THE INVENTION

Therefore, the present invention has been made in an effort to solve the above-described problems.

It is an objective of the present invention to provide a system and method that can inexpensively and effectively transmits an advertisement (advertising material) and then confirms whether it is rightly broadcasted or not via on-line.

To achieve the objective, in the present invention, a server-operating company inserts an ID code, which is composed of letters or numbers, to each advertisement and transmits it to a broadcaster. The broadcaster releases the advertisement with the ID code and then the server-operating company reads out the ID code and produces broadcast review code. The broadcast review code is forwarded to a central server of the server-operating company and the server makes a broadcasting result data based on the broadcast review code. The data is sent to advertisers through Internet and make them possible to monitor commercials in real time.

Consequently, the complicated procedure to transmit advertisements and check the broadcasting result is simplified and cost, labor and time are saved.

According to the present invention, advertisers' and broadcaster's computers and an ID code reading device are attached to the central server through wire and/or wireless Internet.

The server inserts a specific ID code to a certain part of an advertisement in a certain way and the advertisement with the ID code is stored and transmitted to the broadcaster's computer. When the broadcaster releases the advertisement, the ID code is caught in the air by the ID code reading device and analyzed to get the broadcasting results of the advertisement. The results are stored in the server and transferred to the advertiser's computer. In order to read out the ID code released from the radio frequency, the ID code reading device is set up at a place, easy to receive the electric wave, connected with the central server via wire and/or wireless Internet. Once the ID code is decoded, broadcasting date, time and broadcasting length (or seconds) information are processed to a broadcast review code of each broadcast network and the broadcast review code is sent to the server.

The central server comprises means for inserting ID code by applying a digital watermarking technology which puts the ID code in the commercial invisibly and inaudibly.

Preferably, the ID code contains an advertiser code and a production order code of commercial message for the purpose of classifying the advertiser, advertisement title and content at least.

Moreover, the present invention comprises an advertisement information database, which keeps information related with the ID code and commercials with the ID code embedded, and a broadcast program database which carries the information of radio frequency, program title, broadcasting date and time.

The ID code reading device is composed of a timer and broadcast review code producers for the broadcast stations. The broadcast review code, later forwarded to the central server, has the information of the ID code, radio frequency of related broadcast network, broadcasting date/time and length (seconds). The server stores the broadcast review code in the broadcast results database.

A method of advertisement transmission and broadcast confirmation according to the present invention is made up of four steps.

First, advertisers' and broadcasters' computers and an ID code reading device are linked to a central server through wire and/or wireless Internet. Second, a specific ID code is inserted in a certain part of an advertisement in a certain way and the advertisement which contains the ID code is stored in the server and transmitted to the broadcaster's computer. Third, the ID code read out by the ID code reading device, radio frequency of the broadcast station, broadcasting date, time and length (or seconds) information are processed to the broadcast review code of each broadcast network and the broadcast review code is sent to the server. Lastly, broadcasting results of each advertiser is made from comparing and analyzing the broadcast review code of each broadcast network transmitted from the ID code reading device and it is reported to the advertiser's computer in real time.

The ID code includes the information of the advertiser and production order of commercial message. The ID code, advertisement information containing an advertiser's name, a product name and an advertisement title and commercial message are organized as a database and stored in the server.

The ID code is embedded in a certain part of commercial message in a certain way by digital watermarking technology.

Preferably, the central server accumulates all the information of the program title, radio frequency, and a broadcasting date/time to establish a database. The broadcast review codes for the broadcast stations are also stored and organized as a database.

The server-operating company receives a certain amount of money from the advertiser for the payment of commercial management and broadcast results review.

### BRIEF DESCRIPTION OF THE DRAWINGS

FIG. 1 is a schematic diagram illustrating a system of an advertisement transmission and broadcast confirmation via on-line according to a preferred embodiment of the present invention; and

FIG. 2 is a flowchart explaining a method of an advertisement transmission and broadcast confirmation via on-line according to a preferred embodiment of the present invention.

### BEST MODES FOR CARRYING OUT THE PRESENT INVENTION

Hereinafter, the whole process of present invention will be explained in more detail with the accompanying drawings.

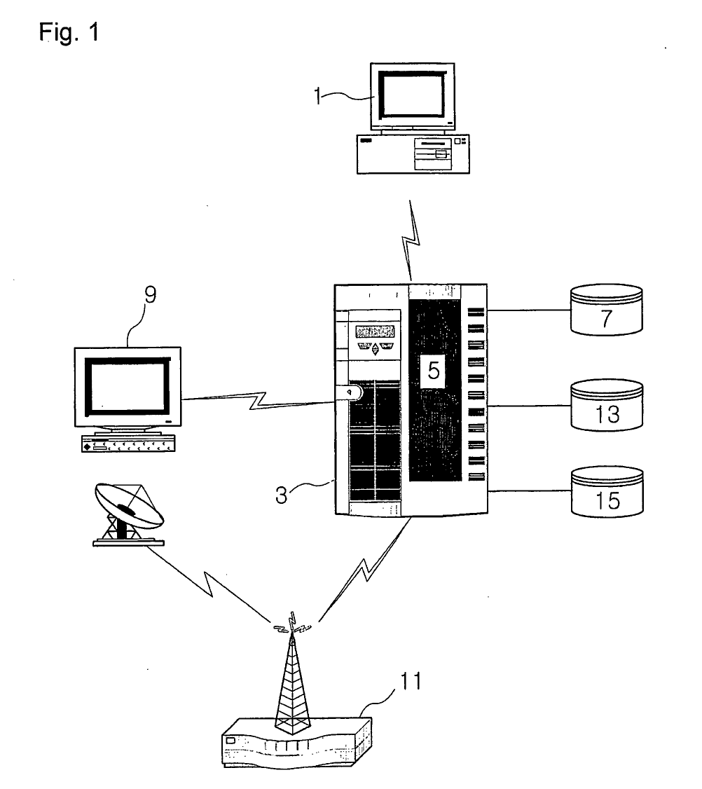

FIG. 1 shows a structure of an advertisement transmission and broadcast confirmation system via on-line according to a preferred embodiment of the present invention.

As shown in the drawing, the inventive system comprises an advertisers' computers 1, a broadcasters' computers 9, an ID code reading device 11, and a central server 3 linked with wire and/or wireless Internet 3.

An advertising material is made into a digital file like MPEG or a video/recording tape and sent to the central server 3 via Internet or delivered by mail or by person in the form of the video/recording tape to the server-operating company. The server-operating company inserts an ID code to the advertising material by using processor 5 in order to distinguish each commercial. Not only the ID code but also the other information such as the advertiser's name, product name and advertisement title are stored and established as an advertisement information database 7.

The following Table 1 shows the ID code of the advertisement, which has the information of advertisement production order for the purpose of classifying advertiser, advertisement title and content at least. In addition, the ID code may include the information of advertisement media and product.

TABLE 1

| | | |
|---|---|---|
| 133640 | Advertiser Code | Advertiser's name (i.e. AA Bakery) |
| 011 | Production Order of | Eleventh Production (i.e. BB Chocolate, |
| | Advertisement | Scent of Heart Series) |

The following Table 2 is an example of advertisement information database 7 stored in the server 3.

TABLE 2

| | |
|---|---|
| ID code | 133640 011 |
| Advertiser's Name | AA Bakery |
| Product Name | BB Chocolate |
| Advertisement Title | Scent of Heart Series |
| Length (Seconds) of Commercial | 30 sec |

After recording advertisement information in database 7 as above, the ID code is inserted to each commercial message by applying digital watermarking technology and the commercial message is sent out to the broadcaster's computer 9 via Internet or delivered in the form of the video/recording tape to the broadcast station.

Here, inserting of the ID code is realized by the most well-known digital watermark technology.

The broadcaster releases the advertisement embedded with the ID code in due time. When the commercial message is broadcasted, the server-operating company decodes the ID code from the electric wave through the ID code reading device 11. Besides the ID code which is figured out, the radio frequency of the broadcast station, broadcasting date/time and length (seconds) information, which are made from internal timer, are added and processed to the broadcast review codes for the broadcast stations. After that, ID code reading device 11 sends out the information including the broadcast review codes for the broadcast stations to the central server 3. The following Table 3 is an example of the broadcast review codes for the broadcast stations.

TABLE 3

| | | Radio | | |
|---|---|---|---|---|
| | | Frequency of | | |
| | | Broadcast | Broadcasting | Broadcasting |
| Type | ID code | Station | Date/Time | Length |
| Input | 133640 011 | 89.1 MHz | 020121-131525 | 30 |
| Code | | | | |
| Decode | TV-AA Bakery- | MBC-FM | January 21st, | 30 seconds |
| | BB Chocolate- | (Seoul) | 2002 | |
| | Scent of Heart | | Hr:Min:Sec = | |
| | Series | | 13:15:25 | |

The server 3 secures and keeps a broadcast program database 13 in order to provide program information related with the released commercial message. The server-operating company inputs the program data, such as a radio frequency of broadcast station, a broadcasting date/time and a program title, which are reported via Internet, program information read out by electric wave, program cognition process to the broadcast program database or post-input the program data.

The broadcast program database 13 retains the radio frequency of the broadcast station, broadcasting date/time, and program title at least.

The following Table 4 is an example of the broadcast program database 13.

TABLE 4

| | Radio Frequency | | |
|---|---|---|---|
| | of Broadcast | | |
| Type | Station | Broadcasting Date/Time | Program Title |
| Input | 89.1 MHz | 020121-131500 | Condition of |
| Code | | | Happiness |
| Decode | MBC (Seoul) | Broadcasted at | Condition of |
| | | Hr:Min:Sec = 13:15:00 in | Happiness |
| | | January 21st, 2002 | |

By the way, the server 3 stores the broadcast review code, which is transmitted from the ID code reading device 11, on the broadcast results database 15. Thereafter, the server compares/analyzes the stored data on the broadcast result database 15, the advertisement information database 7 and the broadcast program database 13 through the processor 5 upon advertiser's request. The broadcast result data for the advertisers are made through this procedure and sent to advertiser's computer 1.

The server 3 holds three databases, i.e. the advertisement information database, the broadcast program database and the broadcast results database, for the purpose of facilitating commercial transmission and broadcast review.

In the present invention, there are four processors: an ID code processor, a broadcast program processor, a broadcast review processor for broadcasters, a broadcast review processor for advertisers.

The ID code processor in the server gives and inserts the ID code in the commercial message, stores the commercial message on the advertisement database and then transmits it to the broadcaster.

The broadcast program processor in the server stores the broadcast program information such as the radio frequency of broadcast station which shot the commercial, the broadcast date/time and the program title in the broadcast program database 13.

The broadcast review processor for broadcasters transmit the broadcast review code, which is made from the radio frequency of the broadcast station, the broadcast date/time and the length (seconds) information for the broadcasters, to the broadcast results database 15 in the server 3 and this is included in the ID code reading device 11.

The broadcast review processor for advertisers in the server makes the broadcast review data for the advertisers with comparing and analyzing each database stored in the server 3 upon advertiser's request. This broadcast review data is sent to the advertiser's computer 1.

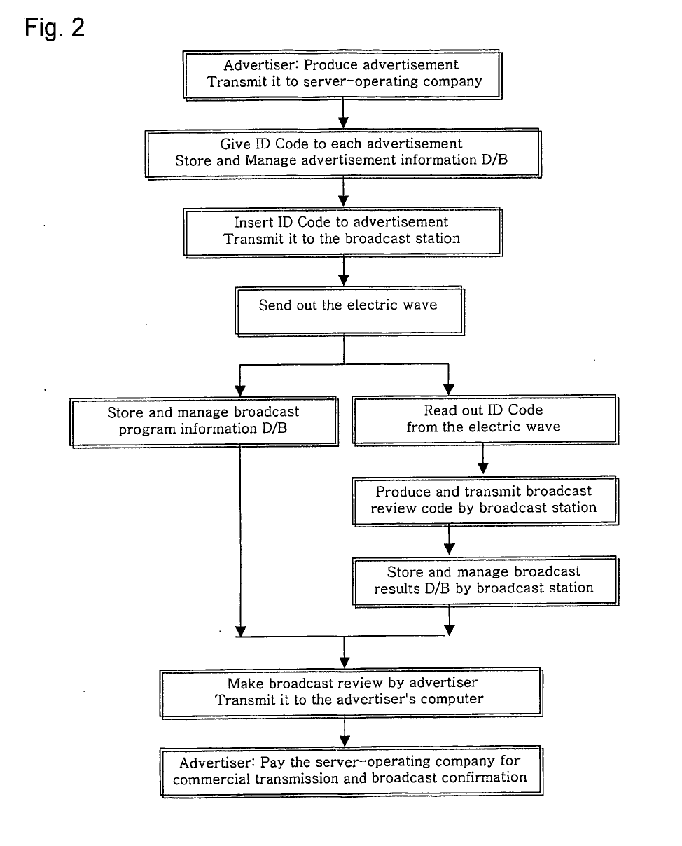

A method for transmitting advertisement and confirming the broadcast of the advertisement according to the present invention will be described hereinafter with reference to FIG. 2.

FIG. 2 shows a flowchart illustrating a process of an advertisement transmission and broadcast confirmation realized by the present invention.

As shown in the flowchart, the advertiser first makes commercial message and transmits it through Internet to the server 3 or delivers it in the form of video/recording tape by mail or by person to the server-operating company.

Then, the server-operating company gives a specific ID code to each advertisement to distinguish each other and stores the ID code and advertisement information in the advertisement information database 7.

The ID code is inserted to the commercial message by using digital watermarking technology and stored with the commercial message.

The server-operating company sends the commercial message with the ID code to the broadcaster's computer 9 or delivers it in the form of video/recording tape by mail or by person to the broadcast station. After that, the broadcast station releases the advertisement on the designated time, and at this point, the ID code is also sent out.

The server-operating company sets up the ID code reading device 11 where it can receive wire/wireless electric wave of the broadcast station and figures out the ID code from the air. Then, the company produces the broadcast review codes for the broadcasters which are composed of the ID code, the radio frequency of the broadcast station, the broadcasting date/time and the length (seconds) information brought out from interior timer in the ID code reading device 11. The broadcast review code is carried out to the server 3 via Internet.

In addition, the server-operating company receives the broadcast program information such as the radio frequency of broadcast station, the broadcasting time and the program title from the broadcaster or other processors and then stores it in the broadcast program database 13.

The server 5 stores the broadcast review code for broadcasters which are received from the ID code reading device 11 in the broadcast results database 15 and produces a broadcast review data for the advertisers through contrasting the broadcast results database 15 with the advertisement information database 7 and the broadcast program database 13 upon advertiser's request. This data is sent out to the advertiser's computer 1 in real time via Internet.

Thereafter, the advertiser pays the server-operating company a certain amount of money for commercial transmission and broadcast review. At this point, a payment gateway is linked between the advertiser's computer and the server and the money is approved.

### INDUSTRIAL APPLICABILITY

As explained above, an advertisement transmission and broadcast confirmation system via Internet according to the present invention, makes it possible to insert the ID code in the advertisement, read out the ID code when the commercial is released and check the broadcast review in real time. The present invention makes network between the advertiser and the server through Internet and has effect on managing the whole procedure efficiently.

Moreover, the present invention can lessen the advertiser's cost, labor and time of advertisement transmission and broadcast review to bring economic benefit. In case of the broadcast networks, cost and labor of commercial storage and edition are reduced.

1. An advertisement transmission and broadcast confirmation system via on-line, the system comprising:
a server linked with advertisers' and broadcasters' computers, the server including a processor for giving and inserting an ID code to each advertisement submitted by advertisers and transmitting the advertisement with the ID code to the broadcaster's computer, comparing and analyzing the ID code, which is read out from electric wave released by the broadcaster by wire and/or wireless, confirming a broadcast result, and then storing and transferring the broadcast result in the server and to the advertisers' computer; and
ID code reading means, disposed at a place to receive electric wave of broadcast station and linked to the server via wire and/or wireless internet, for reading out the ID code sent out by the broadcaster by wire and/or wireless and transmitting not only the ID code but also radio frequency of the broadcast station, broadcasting date/time and length (seconds) to the server.

2. The system of claim 1 wherein the server further comprises means for inserting invisible/inaudible ID code into the advertisement by applying a digital watermarking.

3. The system of claim 1 wherein the ID code comprises information of an advertiser and an advertisement production order.

4. The system of claim 1 wherein the server comprises an advertisement information database and a broadcast program database, the advertisement information database storing the ID code and an advertisement information concerned with the ID code and the broadcast program database storing an information related with a broadcast program which includes a radio frequency of the broadcast station, a program title and a broadcasting date/time.

5. The system of claim 1 wherein the ID code reading means comprises a timer and broadcast review code producers for the broadcaster, the ID code reading means transmitting the broadcast review code for the broadcast station which contains the ID code, a radio frequency of the broadcast station, a broadcasting date/time and a length that are obtained from the timer.

6. The system of claim 5 wherein the server further comprises a broadcast review database for storing the broadcast review code received from the ID code reading means.

7. A method for transmitting an advertisement and confirming a broadcast of the advertisement via an on-line, the method comprises the steps of:
(a) linking advertisers' and broadcasters' computers and an ID code reading device to a server via wire and/or wireless Internet;
(b) giving an ID code to each advertisement submitted by advertisers, inserting the ID code to the advertisement and transmitting it to the broadcasters' computer;
(c) producing and transmitting a broadcast review code for the broadcast station to the server, the broadcast review code includes the ID code which is read out from wire or wireless electric wave of a broadcast station, a radio frequency of broadcast station, a broadcasting date/time and a broadcasting length(seconds); and
(d) making broadcast review for an advertiser from comparing/analyzing the broadcast review code which is received from the ID code reading means and sending the review to advertisers' computer in real time.

8. The method of claim 7 wherein the ID code comprises information of an advertiser and an advertising production order.

9. The method of claim 7 wherein the step (b) further comprises the step of storing an advertisement database in the server, the advertisement database comprising information of the ID code, an advertiser, a product name and an advertisement title.

10. The method of claim 7 wherein the step (b) further comprises the step of inserting the ID code in the advertisement by using a digital watermarking technology.

11. The method of claim 7 wherein the server comprises a broadcast program database having a radio frequency of a broadcast station, a program title and a broadcasting date/time.

12. The method of claim 7 wherein in the step (d), the server stores and manages a broadcast review code for the broadcast station received from the ID code reading means in the form of database.

13. The method of claim 7 further comprising the step of (e) paying a certain amount of money for transmitting and checking the broadcast review.
